(19) United States
(12) Patent Application Publication
(10) Pub. No.: US 2003/0069677 A1
(43) Pub. Date: Apr. 10, 2003

(54) Utilization of data provided by remote sensing devices for protection device activation decisions

(76) Inventors: Canice Patrick Boran, Northville, MI (US); Paul Kirk Zoratti, South Lyon, MI (US)

Correspondence Address: BRINKS HOFER GILSON & LIONE, P.O. Box 10395, Chicago, IL, 60610, US

(21) Appl. No.: 09/974,098

(22) Filed: Oct. 10, 2001

(51) Int. Cl. B60R 21/32

(52) U.S. Cl. 701/45; 280/735; 180/271

(57) ABSTRACT

Methods of activating protection devices in a motor vehicle are provided. The method involves monitoring for objects in the environment of the vehicle and for impact events involving the vehicle, evaluating data based on the monitoring activities, formulating an activation plan based on the data evaluation, and activating the protection devices. The invention allows activation decisions that are based on evaluation of data relating to both impact events and the surrounding environment.

### FIELD OF THE INVENTION

This invention relates to methods of using data from one or more remote sensing devices in the activation of various protection devices in a vehicle. More specifically, the invention relates to methods of activating protection devices that include making decisions based upon data from both impact sensors and remote sensing devices.

### BACKGROUND OF THE INVENTION

Almost all passenger motor vehicles presently produced include some type of impact deployed restraint system to protect vehicle occupants, or others, during a vehicle impact event. Such restraint systems may include, for example, front and side airbags within the passenger compartment, side curtains, inflatable seat belts, and seat belt pretensioners. A restraint system may also include deployable restraints for the protection of pedestrians involved in impacts with the vehicle, such as pedestrian airbags and hood release mechanisms. Sensing systems typically control the deployment of such restraints by detecting the occurrence of a vehicle impact event.

During most impact events, the opportunity to provide occupant restraint exists only for a very brief period of time. Furthermore, inadvertent deployment of a restraint, such as an airbag, is undesirable. Therefore, to be most effective, impact deployed restraints must deploy quickly when needed, and only when actually needed. To this end, impact sensors must be able to discriminate between severe and relatively harmless impact events and also be insensitive to mechanical inputs which are not associated with crash events. Most importantly, however, the design of the sensor must allow for rapid detection of the impact event and transmission of relevant information to allow for effective deployment decisions. The need for a sensor which allows for rapid deployment decisions is particularly great with side airbags, where the crush zone is much smaller than that associated with front airbags, and the time available for a deployment decision is likewise shorter.

Several types of sensors have been used for detection of impact events in vehicles. For example, sensors comprised of piezoelectric cables, accelerometers, pressure sensors and crush-zone switches, have been utilized. While these sensors can operate adequately, it is desirable to improve the ability of vehicle impact sensing systems to discriminate between impact events, such as vehicle crashes, that warrant deployment of a passive restraint, and those that do not, such as a minor impact with a shopping cart.

### SUMMARY OF THE INVENTION

In its embodiments, the invention provides a method of activating protection devices in a motor vehicle. In a preferred embodiment, a method of the present invention comprises providing a remote sensing device, providing an impact sensor, providing a control module, transmitting a first data set from the impact sensor to the control module, transmitting a second data set from the remote sensing device to the control module, evaluating the first and second data sets in consideration of each other, formulating an activation plan, and activating the protection devices in accordance with the plan.

### BRIEF DESCRIPTION OF THE DRAWINGS

FIG. 1 is a schematic plan view of a vehicle, that includes impact sensors and a remote sensing device suitable for use in the present invention.

FIG. 2 is a schematic illustrating the relationships between the remote sensing devices, impact sensors, control module, and protection devices in accordance with a preferred method of the present invention.

FIG. 3 is a flow chart illustrating a preferred method of the present invention.

### DETAILED DESCRIPTION OF THE PREFERRED EMBODIMENTS OF THE INVENTION

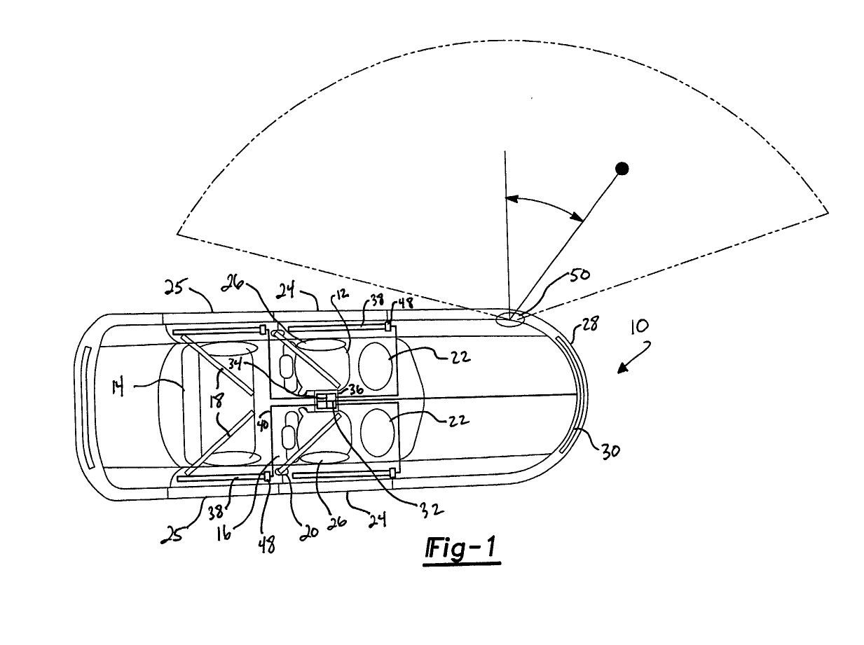

FIG. 1 illustrates a vehicle 10 suitable for use in the methods of the invention. The vehicle 10 has front 12 and rear 14 seats in a passenger compartment 16. Mounted in proximity to each seat is a seat belt 18, each of which may be equipped with pretensioners 20 as deployment restraints. Mounted in front of the two front seats 12 are front airbags 22. The illustrated vehicle 10 includes two front doors 24 and two rear doors 25, all of which may include a side airbag 26 mounted adjacent the front 12 and rear 14 seats. The vehicle 10 has a front bumper 28 with a pedestrian airbag 30 mounted in proximity to the bumper 28.

Various impact sensors are mounted to the vehicle 10. Any suitable type of impact sensor can be used. Preferably, the impact sensors of the vehicle 10 include one or more accelerometers and one or more deformation sensors. Preferably, the vehicle 10 has a first frontal accelerometer 32 oriented to sense longitudinal acceleration of the vehicle and a second side accelerometer 34 oriented to sense side-to-side (i.e., lateral) acceleration. Alternatively, the two accelerometers 32, 34 can be replaced with a single dual-axis acceleration sensor if so desired.

Also preferable, the vehicle 10 has several deformation sensor elements 38 located at various positions. The sensor elements 38 may be utilized in several areas of the vehicle. Generally, the sensor elements 38 will be mounted in areas around the body of the vehicle 10 in which impact sensing is desired, i.e., areas in which impact events are known to occur. For example, as illustrated in FIG. 1, the sensor elements 38 may be disposed within a door 24 of the vehicle 10 for detecting side impact events. Also, a sensor element 38 may be disposed near or within a bumper 28 of the vehicle 10. So disposed, the element 38 can be utilized to monitor for impact events involving pedestrians. Other locations may, of course, be desirable. No matter where located, the sensor element 38 is preferably disposed in a manner that allows direct detection of an impact event. That is, the sensor element 38 is disposed in a manner that ensures its physical involvement in an impact event generating sufficient deformation of the vehicle 10.

The term “deformation sensor” is used to describe sensors capable of this direct physical involvement in vehicle impact events causing sufficient deformation of the vehicle 10. For example, as shown in FIG. 1, the sensor element 38 may be disposed on a structural element of a vehicle door 24. In this configuration, the sensor element 38 will directly participate in a side impact event affecting the vehicle door 24. Also, for monitoring pedestrian and frontal impact events, the sensor element 38 may be directly embedded in the compressible material of the bumper 28.

Preferably, the sensor element 38 comprises a bend sensitive resistance element. Bend sensitive resistance elements, such as the flexible potentiometer disclosed in U.S. Pat. No. 5,583,476 to Langford, provide electrical signals that vary as the element is deformed. Commonly-owned international application number PCT/US00/26522 provides a detailed description of a vehicle impact sensing system that utilizes bend sensitive resistance elements. A bend sensitive resistance element is only one example of the type of sensor that can be used as the sensor element 38 in the invention. As such, the specific example of a bend sensitive resistance element is only illustrative in nature and is not intended to limit the scope of the present invention in any way.

Alternatively, any other suitable impact sensor can be used. The impact sensor need only be able to detect an impact event and relay a data set regarding the impact event to a control module. Accordingly, suitable alternatives include other types of deformation sensors. For example, the sensor element 38 may be a piezoelectric cable or a fiber-optic cable. No matter the type of deformation sensor utilized, the sensor element 38 can be either a unitary item spanning the length of a vehicle structural element, or may be a plurality of elongate sensor elements 38 horizontally situated so as to be capable of providing azimuthal resolution of impact events.

The impact sensors are adapted to output a first data set relating to the impact event detected by the sensor. The impact sensors relay this data set to the control module, via the signal processing module if present.

The first data set comprises various data related to the impact event (or lack thereof), and can include any such data collected by the impact sensor. The type of data will depend on the type of impact sensor utilized. Examples of suitable data for the first data set include impact location, angle of impact, mass of impacting object, and severity of the impact event.

The remote sensing device 50 can be any suitable device adapted to output a data set relating to the presence, location and/or relative velocity of objects in the vicinity of the host vehicle 10. Conventional remote sensing devices comprise a detector of some type, such as radar and optical electromagnetic radiation detectors, that scans a defined field and gathers data regarding objects within the field. The field represents an area of the environment surrounding the vehicle. The sensing device can report the data in terms of range (distance) and azimuth (bearing) from a reference point on the vehicle. The reference point is typically the location of the sensing device on the vehicle. Also, relative velocity between the vehicle and a detected object can be calculated in terms of relative motion between the object and reference point. The remote sensing device typically updates all data at a regular interval, for example, every 20 milliseconds. By maintaining a history of location and relative velocity data, a true trajectory for each object within the field can be reached.

Examples of suitable remote sensing devices for use in the invention include those described in U.S. Pat. No. 6,085,151 to Farmer, et al. for a PREDICTIVE COLLISION SENSING SYSTEM; U.S. Pat. No. 5,959,552 to Cho for a SYSTEM FOR MINIMIZING AUTOMOBILE COLLISION DAMAGE AND PERSON INJURY; U.S. Pat. No. 5,541,590 to Nishio for a VEHICLE CRASH PREDICTIVE AND EVASIVE OPERATION SYSTEM BY NEURAL NETWORKS; U.S. Pat. No. 6,097,332 to Crosby for a RADAR DETECTOR FOR PRE-IMPACT AIRBAG TRIGGERING; and U.S. Pat. No. 6,087,928 to Kleinberg, et al. for a PREDICTIVE IMPACT SENSING SYSTEM FOR VEHICULAR SAFETY RESTRAINT SYSTEMS.

The impact sensors are preferably in electrical communication with the restraints control module 36 via electrical connections 40. There may be a signal-processing module 48 electrically situated between the accelerometers 32, 34 and the control module 36 as well as between the deformation sensors 38 and the restraints control module 36. The restraints control module 36 is also preferably electrically connected to the various protection devices of the vehicle 10.

The remote sensing device 50 is also in electrical communication with the control module 36. A signal-processing module may also be disposed between the remote sensing device 50 and control module 36, if appropriate.

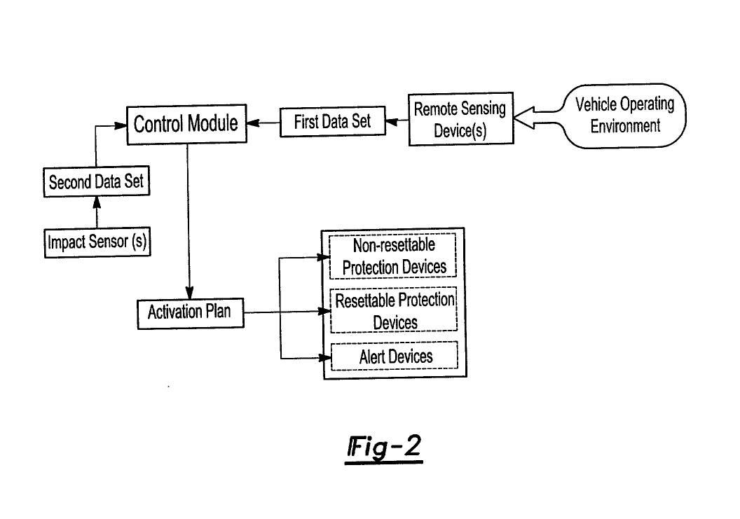

FIG. 2 illustrates a schematic of the relationships between the various elements described above. The remote sensing device monitors the vehicle operating environment for external objects and outputs a first data set relating to detected objects to the control module.

Likewise, the impact sensors, upon detection of an impact event, output a second data set relating to the impact event to the control module. Upon receiving both data sets, the control module evaluates the first and second data sets in consideration of each other. Based on this evaluation, the control module formulates an activation plan for the protective devices, and subsequently activates the various protective devices, if appropriate, in accordance with the activation plan. Preferably, this method is performed repetitively at a fixed interval, such as every 20 milliseconds.

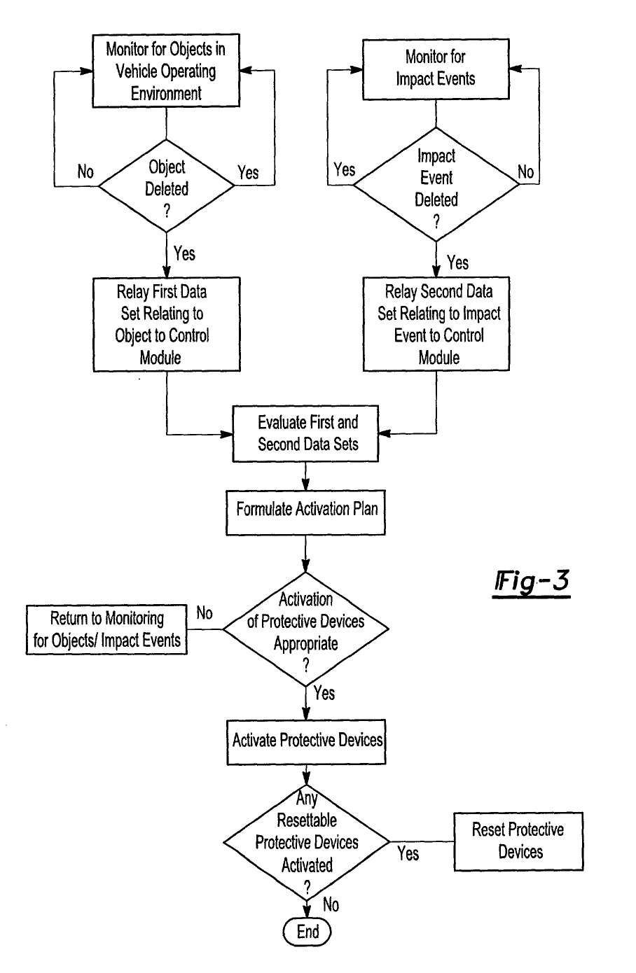

FIG. 3 illustrates a flow chart of a preferred method of practicing the invention. Initially, the remote sensing device and impact sensors monitor for objects in the vehicle operating environment and impact events, respectively. The monitoring is conducted in accordance with the principles of operating of the appropriate device or sensor. Preferably, the devices and sensors perform the monitoring at a regular interval, such as every 20 milliseconds. Alternatively, a periodic or random interval can be utilized. Also preferable, monitoring continues whether an object and/or impact event is detected or not.

When the remote sensor device or impact sensor detects an external object or an impact event, respectively, the device or sensor transmits a data set to the control module. The impact sensors transmit a first data set that contains data relating to the detected impact event. Suitable data in the first data set includes impact location, angle of impact, mass of impacting object, and severity of the impact.

The remote sensing device transmits a second data set that contains data relating to the detected object. Suitable data in the second data set includes range and/or azimuth from a reference point and relative velocity. The second data set can also include a trajectory of the object relative to the vehicle.

Alternatively, the impact sensor and/or remote sensing device can transmit their respective data sets repetitively over an interval of time. Preferably, the interval is a regular interval, such as every 20 milliseconds.

Preferably, both data sets are transmitted to the control module. The control module then evaluates the data contained in both data sets. Preferably, the control module evaluates the data sets in consideration of each other. That is, it is preferred that the control module evaluate data in the first data set (related to objects in the vehicle operating environment) in light of data in the second data sets (related to impact events). For example, if the first data set indicates that an object is in the operating environment of the vehicle and is traveling toward the vehicle, and the second data set indicates that an impact event has not occurred, the control module could evaluate the data sets and conclude that an impact event is about to occur. Furthermore, if the first data set indicates that no object is traveling toward the vehicle and the second data set indicates that an impact event has occurred, the control module could evaluate the data sets and conclude that a crash is likely completed.

Next, the control module formulates an activation plan based on the evaluation of the data sets. The activation plan represents a profile of activation signals for the various protective devices located in the vehicle. Preferably, the activation plan contains an activation signal for each protective device associated with the vehicle. The activation signal represents an electronic, mechanical or other signal appropriate for activating (or not activating) a particular protective device. Also preferable, the activation signal for a particular device represents a desired degree of activation, as opposed to simply a signal that corresponds to either “activate” or “do not activate.” Particularly preferable, for each protective device capable of responding to such signals, the activation plan contains activation signals that correspond to desired degrees of activation based on the evaluation of the first and second data sets.

For example, if the evaluation of the first data set indicates that a minor impact is going to occur, a desired protective device, such as an airbag, can be activated at a lower degree, such as less fully inflated or less intensely and/or quickly inflated.

After the activation plan is formulated, the control module activates the protective devices that have an activation signal in the activation plan. That indicates that the device should be deployed or made active. The activation is conducted to the degree indicated by the activation signal.

If the one or more of the protective devices are resettable, the method can further comprise resetting the resettable protective device after the impact event. Examples of resettable protective devices include alarms that emit an audible signal and seat belt pretentioners.

The references cited in this disclosure, except to the extent they may contradict any statements or definitions made herein, are hereby incorporated by reference in their entirety.

The foregoing disclosure includes the best mode devised by the inventors for practicing the invention. It is apparent, however, that various modifications and variations of the present invention may be conceivable to one skilled in the relevant art. Inasmuch as the foregoing disclosure is intended to enable such person to practice the instant invention, it should not be construed to be limited thereby but should be construed to include such aforementioned variations and be limited only by the spirit and scope of the following claims:

We claim:

1. A method of activating one or more protection devices in a motor vehicle, comprising:
providing an impact sensor adapted to detect an impact event involving said vehicle;
providing a remote sensing device adapted to gather information about objects in the environment of said vehicle;
providing a control module operably connected to the remote sensing device, impact sensor, and said protection devices;
transmitting a first data set from the impact sensor to the control module;
transmitting a second data set from the remote sensing device to the control module;
evaluating the first and second data sets in consideration of each other;
formulating an activation plan that contains an activation signal for each of said protection devices; and
activating said protection devices in accordance with the activation plan.

2. A method in accordance with claim 1, wherein at least one of said protection devices comprises a resettable protection device and further comprising resetting the resettable protection device.

3. A method in accordance with claim 1, wherein the first data set comprises data related to an impact event detected by the impact sensor.

4. A method in accordance with claim 3, wherein the data includes information related to one or more of the location of the impact event, angle of the impact event, mass of object impacting said motor vehicle in the impact event, and severity of the impact event.

5. A method in accordance with claim 1, wherein the second data set comprises data related to objects within the environment of said vehicle.

6. A method in accordance with claim 5, wherein the data includes information related to the range or azimuth of an object relative to a reference point.

7. A method in accordance with claim 6, wherein the reference point comprises the location at which the remote sensing device is located on the vehicle.

8. A method in accordance with claim 1, wherein transmitting a first data set and transmitting a second data set is repetitively performed at an interval of time.

9. A method in accordance with claim 8, wherein the interval of time comprises a regular interval of time.

10. A method in accordance with claim 9, wherein the interval of time comprises 20 milliseconds.

11. A method in accordance with claim 1, wherein at least one activation signal represents a desired degree of activation of an appropriate one of said protection devices.

12. A method of activating one or more protection devices in a motor vehicle having an impact sensor outputting a first data set related to an impact event involving said motor vehicle, and a remote sensing device outputting a second data set related to objects within the environment of said vehicle, the method comprising:
evaluating the first and second data sets in consideration of each other;
formulating an activation plan that contains an activation signal for each of said protection devices; and
activating said protection devices in accordance with the activation plan.

13. A method in accordance with claim 12, wherein the evaluating the first and second data sets in consideration of each other is conducted by a control module operably connected to said impact sensor, said remote sensing device, and said protection devices.

14. A method in accordance with claim 12, wherein the evaluating the first and second data sets is repetitively performed at an interval of time.

15. A method in accordance with claim 14, wherein the interval of time comprises a regular interval of time.

16. A method in accordance with claim 15, wherein the interval of time comprises 20 milliseconds.

17. A method of activating one or more protection devices in a motor vehicle comprising:
monitoring for objects in the environment of said motor vehicle;
monitoring for impact events involving said motor vehicle;
transmitting a first data set relating to the monitoring for objects;
transmitting a second data set relating to the monitoring for impact events;
evaluating the first and second data sets in consideration of each other;
formulating an activation plan that contains an activation signal for each of said protection devices; and
activating said protection devices in accordance with the activation plan.

18. A method in accordance with claim 17, wherein the first data set includes information related to one or more of the impact event, angle of the impact event, mass of object impacting said motor vehicle in the impact event, and severity of the impact event.

19. A method in accordance with claim 17, wherein the first data set includes information related to the range or azimuth of an object relative to a reference point.

20. A method in accordance with claim 19, wherein the reference point comprises the location at which the remote sensing device is located on the vehicle.

21. A method in accordance with claim 17, wherein the monitoring for objects and monitoring for impact events are conducted at a regular interval.

22. A method in accordance with claim 20, wherein the interval is 20 milliseconds.

23. A method in accordance with claim 17, wherein the transmitting a first data set and transmitting a second data set are conducted at a regular interval.

24. A method in accordance with claim 22, wherein the interval is 20 milliseconds.
